(19) United States
(12) Patent Application Publication
(10) Pub. No.: US 2002/0191917 A1
(43) Pub. Date: Dec. 19, 2002

(54) Transceiver device for transmitting and receiving optical signals

(75) Inventors: Li Wu, (US); Jiwu Ling, (US); Zhiguo Hong, (US); Hanqi Wu, (US); Jianquan Huang, (US); Cuilian Zhan, (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/167,009

(22) Filed: Jun. 11, 2002

(30) Foreign Application Priority Data
Jun. 18, 2001 (CN) 01238396.1

(51) Int. Cl. G02B 6/26; G02B 6/293; H04B 10/00

(52) U.S. Cl. 385/47; 385/24; 359/152

(57) ABSTRACT

The invention provides a transceiver including a ball lens, an optical filter disposed within the ball lens for transmitting a first optical signal at a first wavelength and for reflecting a second optical signal at a second wavelength, a light source for emitting the first optical signal to the ball lens, a receiver for receiving the second optical signal from the ball lens, and an input/output port optically coupled with the ball lens for at least one of receiving the first optical signal from the ball lens and transmitting the second optical signal to the ball lens. The ball lens comprises two half ball lenses and the optical filter is disposed at a mid-plane junction between the two half ball lenses.

### CROSS-REFERENCE TO RELATED APPLICATIONS

This applications claims priority of Chinese Patent Application No. 01238396.1 filed on Jun. 18, 2001, entitled “Photon-electronic Transceiver” which is incorporated herein by reference for all purposes.

### MICROFICHE APPENDIX

Not Applicable

### FIELD OF THE INVENTION

The present invention generally relates to an optical communication device, and more particularly to a transceiver device for transmitting and receiving optical signals.

### BACKGROUND OF THE INVENTION

Fiber-optic technology has completely penetrated the telecommunications industry and continues to expand into many areas outside of communications. More applications are coming as fiber optics and other technologies develop, such as fiber-optic systems to provide a broad array of new and existing communication services (e.g. telephone and cable television) to homes and businesses.

Transmitters and receivers are essential elements of a fiber-optic system. An optical transmitters generate the signals sent through fiber-optic cables. They can range from cheap LEDs to more sophisticated lasers. Fiber-optic receivers detect light signals that are transmitted through a fiber and convert them into electrical form. Receivers can come in many varieties, from simple photo-detectors to sophisticated systems that perform considerable processing to extract a signal.

A fiber-optic transmitter may be packaged with a receiver as a so-called transceiver to provide bi-directional optical communication. The general function of a transceiver is presented in FIG. 1. A transceiver 100 includes a transmitter 110, such as a semiconductor laser LD, emitting an optical signal at a wavelength λ₁, and a receiver 140, such as a photo-diode detector, receiving a signal at a wavelength λ₂. The transmitted signal at wavelength λ₁ passes through a WDM filter 120 before being transmitted through a transmission fiber 130. By converting the optical signal into an electrical signal, both functions of signal receiving and transmitting are obtained.

At present, such kind of transceivers are still fairly expensive, in particular for home user applications. Market requirements demand small modules with cost effective transmitters and receivers.

Further, there are continuing efforts to improve coupling links in optical fiber communication systems including improvements in manufacturing simplicity, system packaging flexibility to permit a single lens arrangement to accommodate a plurality of applications, and cost reduction of optical and optoelectronic components.

Therefore, technology for integrating an optical receiver apparatus and an optical transmitter apparatus in a compact package is in great demand. Furthermore, there is a need to reduce the costs for such transceivers.

It is an object of this invention to provide an improved transceiver.

Another object of this invention is to provide a small and/or cost effective transceiver.

A further object of the invention is to provide a single ball lens for use with a transmitter and receiver.

### SUMMARY OF THE INVENTION

In accordance with the invention there is provided a transceiver comprising a ball lens, an optical filter disposed within the ball lens for transmitting a first optical signal at a first wavelength and for reflecting a second optical signal at a second wavelength, a light source for emitting the first optical signal to the ball lens, a receiver for receiving the second optical signal from the ball lens, and an input/output port optically coupled with the ball lens for at least one of receiving the first optical signal from the ball lens and transmitting the second optical signal to the ball lens.

In accordance with an embodiment of the invention the optical filter and the ball lens are integral.

In accordance with another embodiment of the invention, the ball lens comprises two half ball lenses. The optical filter is disposed at a mid-plane junction between the two half ball lenses. The two half ball lenses can be glued together or held together by mounting means.

In an embodiment of the invention, the two half ball lenses are of a substantially same size and shape so as to form the mid-plane junction in the middle of the ball lens.

In a further embodiment of the invention, a distance between the light source and the ball lens is substantially the same as a distance between the receiver and the ball lens for minimizing a package size of the transceiver. Furthermore, an angle between a normal to a reflecting plane of the optical filter and an optical axis of the transceiver is approximately 45 degrees to minimize the package size. However, if it is desired to minimize PDL, the angle between the normal to the reflecting plane of the optical filter and the optical axis of the transceiver is approximately 10-15 degrees which increases the package size from its minimum at 45 degrees.

In accordance with yet another embodiment of the present invention, the transceiver further comprises a waveguide optically coupled to the input/output port for transmitting the first and the second optical signal.

In accordance with the invention, there is further provided, a transmitter/receiver for a bi-directional optical transmission system comprising a ball lens, a WDM filter disposed within the ball lens for transmitting a first optical signal and for reflecting a second optical signal, a laser diode for emitting the first optical signal, a light receiver for receiving the second optical signal transmitted thereto, an input/output port optically coupled to the ball lens for at least one of receiving the first optical signal from the ball lens and transmitting the second optical signal to the ball lens, and an optical waveguide optically coupled to the input/output port for transmitting at least one of the first and the second optical signal, wherein the ball lens is for collimating the first optical signal received from the laser diode and the second optical signal received from the input/output port and for focusing the first optical signal to the input/output port and the second optical signal to the light receiver.

In accordance with an embodiment of the invention, the ball lens comprises two half ball lenses and the WDM filter is disposed at a mid-plane junction between the two half ball lenses.

Advantageously, the invention provides a transceiver wherein a single ball lens can be used for the transmitter and the receiver, hence providing a smaller and more cost effective transceiver having fewer parts.

### BRIEF DESCRIPTION OF THE DRAWINGS

Exemplary embodiments of the invention will now be described in conjunction with the following drawings wherein like numerals represent like elements, and wherein:

FIG. 1 shows a schematic block diagram presenting the general function of a transceiver;

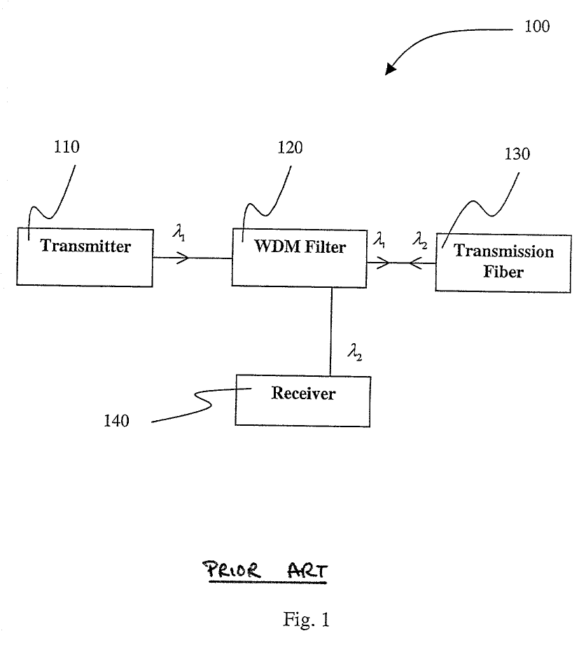

FIG. 2 shows a schematic side view of a transceiver in accordance with the present invention; and

FIG. 3 shows a schematic side view of a packaged transceiver in accordance with the present invention.

### DETAILED DESCRIPTION OF THE PREFERRED EMBODIMENTS

The present invention employs a single ball lens for use with a transmitter and a receiver. Ball lenses are one of the physically simplest and most economical micro-optic elements to manufacture and mount. The ball lens in accordance with the present invention integrates three optical components, two lenses and a WDM filter. Such an integrated ball lens is useful in combining the functionality of a transmitter and a receiver in a same package.

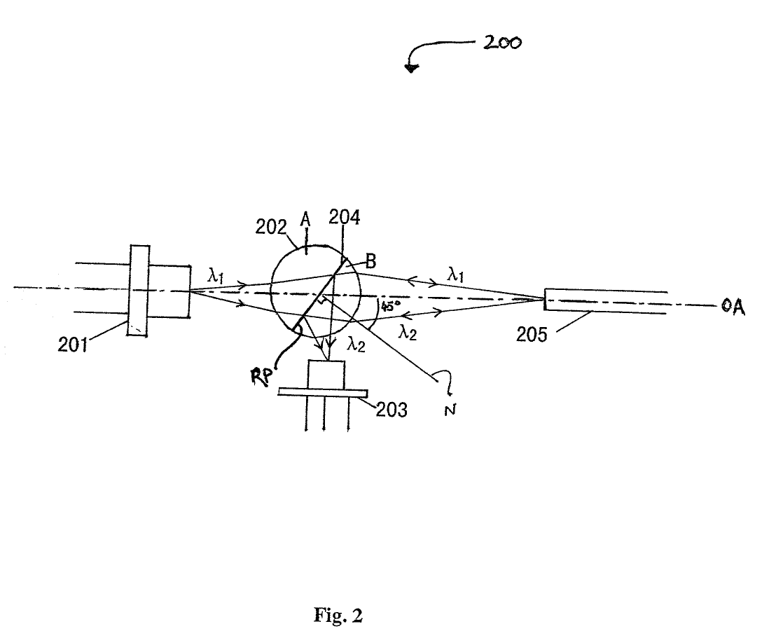

Turning now to FIG. 2, a schematic side view of an exemplary transceiver 200 in accordance with the present invention is presented. Transceiver 200 includes a laser diode (LD) 201, a photo diode receiver 203, a fiber 205, and a ball lens 202. The ball lens 202 can be formed by cutting a conventional ball lens into two portions, preferably halves A and B, forming a WDM filter 204 at a mid-plane junction between the halves A and B. However, the ball lens 202 may also be integrally formed with the WDM filter 204, such as by insert injection molding of the ball lens with the WDM filter 204 inserted in the mold. The WDM filter 204 may be formed by any common WDM filter technology known in the art. The ball lens can be made from a glass, crystal, semiconductor, or a polymer material. Advantageously, the halves A and B are of a same size and shape such that the mid-plane junction in which the WDM filter 204 is formed or disposed, is in the middle of the ball lens. However, the WDM filter 204 can be offset from the middle of the ball lens 202 without departing from the scope or spirit of the present invention. Preferably, the two halves A and B with the WDM filter 204 are cemented or adhered together back into a ball shape with a suitable optical epoxy. However, in accordance with another embodiment of the invention, the components do not have to be adhered to one another, they can also be retained in a ball shape by other means, such as a packaging mount.

The division of the ball lens 202 can be done by cutting or polishing, or directly by forming half balls using a polymer injection molding process or a casting process. However, the ball lens halves can also be formed by conventional grinding.

Looking again at FIG. 2, the laser diode 201 emits an optical signal at a wavelength λ₁ which is then passed through ball lens 202. The WDM filter 204 within the ball lens 202 is transmissive to wavelength λ₁ and allows it to pass therethrough. After the signal λ₁ is passed through the WDM filter 204, the ball lens 202 focuses the signal λ₁ onto fiber 205. Conversely, fiber 205 emits an optical signal at a wavelength λ₂ which is directed towards the ball lens 202. However, the WDM filter 204 within the ball lens 202 reflects the signal λ₂ and the ball lens focuses it onto the photo diode 203 which detects the signal λ₂.

Advantageously, a distance between the photo diode detector 203 and the ball lens 202 is chosen to be approximately the same as a distance between the laser diode 201 and the ball lens 202 in order to minimize a package size of the transmitter/receiver device 200. This optical design also provides for an efficient coupling of signal λ₁ into fiber 205.

As can be seen from FIG. 2, the WDM filter 204 is arranged with an angle of 45 degrees between a normal N to a reflecting plane RP and an optical axis OA. Alternatively, the angle between the normal N to the reflecting plane RP and the optical axis OA is chosen in accordance with specifications pertaining to polarization dependent loss (PDL). For example, in case there are no specific PDL requirements, an incidence angle of 45 degrees is chosen which provides the smallest package size of a transceiver device in accordance with the invention. However, in case of relatively tight PDL specifications, the angle between the normal N to the reflecting plane RP and the optical axis OA is selected to be approximately between 10 to 15 degrees thereby decreasing the angles of incidence on the filter plane and thus reducing the PDL but at a cost of increased package size.

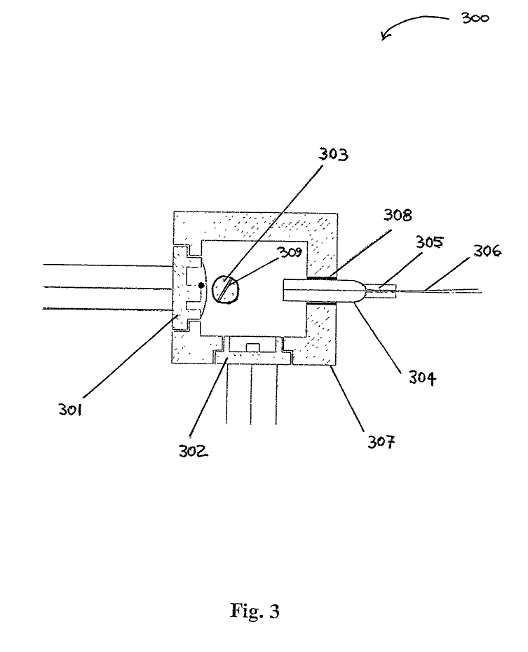

Turning now to FIG. 3, a schematic side view of a packaged transceiver 300 in accordance with the present invention is shown including a laser diode 301, a detector 302, a ball lens 303 comprised of two half ball lenses with a WDM filter 309 therebetween, and a fiber pigtail 304 including fiber sleeve 305 and fiber 306, all provided in a common package 307. The fiber pigtail 304 is shown to be mounted to the package by an epoxy or solder 308.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A transceiver comprising:
a ball lens;
an optical filter disposed within the ball lens for transmitting a first optical signal at a first wavelength and for reflecting a second optical signal at a second wavelength;
a light source for emitting the first optical signal to the ball lens;
a receiver for receiving the second optical signal from the ball lens; and
an input/output port optically coupled with the ball lens for at least one of receiving the first optical signal from the ball lens and transmitting the second optical signal to the ball lens.

2. The transceiver as defined in claim 1 wherein the optical filter and the ball lens are integral.

3. The transceiver as defined in claim 1 wherein the ball lens comprises two half ball lenses.

4. The transceiver as defined in claim 3 wherein the optical filter is disposed at a mid-plane junction between the two half ball lenses.

5. The transceiver as defined in claim 4 wherein the two half ball lenses are of a substantially same size and shape so as to form the mid-plane junction in the middle of the ball lens.

6. The transceiver as defined in claim 5 wherein the two half ball lenses are glued together or held together by mounting means.

7. The transceiver as defined in claim 4 wherein a distance between the light source and the ball lens is substantially the same as a distance between the receiver and the ball lens for minimizing a package size of the transceiver.

8. The transceiver as defined in claim 7 wherein an angle between a normal to a reflecting plane of the optical filter and an optical axis of the transceiver is approximately 45 degrees.

9. The transceiver as defined in claim 7 wherein an angle between a normal to a reflecting plane of the optical filter and an optical axis of the transceiver is approximately 10-15 degrees.

10. The transceiver as defined in claim 1 further comprising a waveguide optically coupled to the input/output port for transmitting the first and the second optical signal.

11. A transmitter/receiver for a bi-directional optical transmission system comprising:
a ball lens;
a WDM filter disposed within the ball lens for transmitting a first optical signal and for reflecting a second optical signal;
a laser diode for emitting the first optical signal;
a light receiver for receiving the second optical signal transmitted thereto;
an input/output port optically coupled to the ball lens for at least one of receiving the first optical signal from the ball lens and transmitting the second optical signal to the ball lens; and
an optical waveguide optically coupled to the input/output port for transmitting at least one of the first and the second optical signal,
wherein the ball lens is for collimating the first optical signal received from the laser diode and the second optical signal received from the input/output port and for focusing the first optical signal to the input/output port and the second optical signal to the light receiver.

12. The transmitter/receiver as defined in claim 11 wherein the ball lens comprises two half ball lenses and the WDM filter is disposed at a mid-plane junction between the two half ball lenses.
